(19) United States
(12) Patent Application Publication
(10) Pub. No.: US 2003/0009349 A1
(43) Pub. Date: Jan. 9, 2003

(54) Remodeling brokerage system and method

(75) Inventor: Taiho Shu, Tokyo (JP)

Correspondence Address: OLIFF & BERRIDGE, PLC, P.O. BOX 19928, ALEXANDRIA, VA, 22320, US

(73) Assignee: FEALS, INCORPORATED COMPANY, Tokyo (JP)

(21) Appl. No.: 10/152,849

(22) Filed: May 23, 2002

Related U.S. Application Data
(63) Continuation of application No. PCT/JP00/08680, filed on Dec. 8, 2000.

(30) Foreign Application Priority Data
Dec. 24, 1999 (JP) 11-365816

(51) Int. Cl. G06F 17/60

(52) U.S. Cl. 705/1

(57) ABSTRACT

An object of this invention is to provide a system for intermediating between a remodeling requester who requests a remodeling associated with a real estate property online and a remodeling contractor. For that purpose, a remodeling brokerage system of this invention has: means for registering a remodeling estimate request; output means for outputting the content of the remodeling estimate request to registered remodeling contractors; means for registering estimates from the registered remodeling contractors with respect to the registered remodeling estimate request; and means for registering information concerning an order in response to selection of a remodeling contractor to which an order is to be issued among the remodeling contractors who registered the estimates. It is also possible to output the content of the remodeling estimate request only to registered remodeling contractors who can carry out the remodeling specified by the remodeling estimate request. In addition, the remodeling estimate request may include information concerning a remodeling example to be referred to, to represent execution image of the requester.

### CROSS-REFERENCE TO RELATED APPLICATIONS

This is a continuation of International Application PCT/JP00/08680, filed Dec. 8, 2000, now abandoned.

### TECHNICAL FIELD OF THE INVENTION

The present invention relates to a system for intermediating between a remodeling requester who requests a remodeling associated with a real estate property, for example, a house and a remodeling contractor.

### BACKGROUND OF THE INVENTION

With respect to things (for example, an airline ticket or a car) in which the content of a service to be provided or the content of a commodity to be sold is relatively clearly grasped and expressed even at a remote place, there exists a buying and selling intermediary system in which a purchaser inputs a desired purchase price, the desired purchase price is outputted to registered dealers, and a dealer accepting the desired purchase price inputs the acceptance. However, there has not existed a system for brokering a remodeling associated with a real estate property online.

### SUMMARY OF THE INVENTION

An object of the invention is, therefore, to provide a system and method for intermediating between a remodeling requester who requests a remodeling associated with a real estate property online and a remodeling contractor.

Another object of the invention is to provide an online remodeling brokerage system and method, which facilitates the expression and grasp of the remodeling execution content by a remodeling requester and a remodeling contractor online.

According to a first aspect of the invention, a remodeling brokerage system for brokering a remodeling associated with a real estate property comprises: means for registering a remodeling estimate request; output means for outputting the content of the remodeling estimate request to registered remodeling contractors; means for registering estimates from the registered remodeling contractors with respect to the registered remodeling estimate request; and means for registering information (for example, identification information of a remodeling contractor to which an order is to be issued, a link information between the estimate request and the estimate, or the like) concerning an order in response to selection of a remodeling contractor to which an order is to be issued among the remodeling contractors who registered the estimates. The aforementioned means for registering stores the remodeling estimate request, the estimate, and information concerning the order into, for example, a storage device.

The foregoing output means may also output that the content of the registered remodeling estimate request to the registered remodeling contractors who can carry out the remodeling specified by the remodeling estimate request. For example, the registered remodeling contractors who can carry out the remodeling specified by the remodeling estimate request are enabled to browse the content of the remodeling estimate request, and the content is outputted in response to the requests from the registered remodeling contractors or is outputted by e-mail or the like.

The remodeling brokerage system according to the first aspect of the invention may further comprise means for selecting the registered remodeling contractors who can carry out the remodeling specified by the remodeling estimate request on the basis of a location of the real estate property where an object of the remodeling estimate request exists.

The aforementioned remodeling estimate request may comprise information concerning a remodeling example to be referred to. By doing so, the remodeling estimate requester can express an image of the remodeling by citing the existing remodeling example. Means for enabling, at the time of registering the remodeling estimate request, search of the information concerning the remodeling example to be referred to may be included.

Besides, the aforementioned output means may also output the information concerning the remodeling example included in the remodeling estimate request to the registered remodeling contractors who can carry out the remodeling specified by the remodeling estimate request. By this, the remodeling contractors can also grasp the intention of the remodeling estimate requester relatively easily, and this is useful for estimate creation.

Further, the remodeling brokerage system according to the first aspect of the invention may further comprise means for outputting or printing an invoice relating to the ordered remodeling. An organizer of the remodeling brokerage system charges the price for the ordered remodeling on behalf of the remodeling contractor and gets a brokerage fee.

Besides, the remodeling brokerage system according to the first aspect of the invention may further comprise means for exhibiting the estimates registered for the remodeling estimate request to a person who registered the remodeling estimate request. For example, although the remodeling contractor to which an order is to be issued may be automatically determined according to an estimated sum of money, here, the person who registered the remodeling estimate request makes an individual judgment. For example, the person who registered the remodeling estimate request can select a highly reliable contractor even if the estimated sum of money is high.

Further, the foregoing estimate may comprise image information expressing the content of the remodeling. This is because the remodeling contractor registering the estimate enables the person who registered the remodeling estimate request to easily understand the content of the remodeling to be carried out.

According to a second aspect of the invention, a remodeling brokerage method for brokering a remodeling associated with a real estate property comprises the steps of: registering a remodeling estimate request; outputting a content of the remodeling estimate request to registered remodeling contractors; registering estimates from the registered remodeling contractors with respect to the registered remodeling estimate request; and registering information concerning an order in response to selection of a remodeling contractor to which an order is to be issued among the remodeling contractors who registered the estimates.

The modifications explained for the first aspect of the invention can also be applied to the second aspect of the invention.

It is also possible to create a program for causing a computer to execute the remodeling brokerage method according to the second aspect of the invention, and the program is stored in a storage medium or a storage device, for example, a floppy disk, a CD-ROM, a magnet-optical disk, a semiconductor memory, or a hard disk.

### BRIEF DESCRIPTION OF THE DRAWING

FIG. 1 is a block diagram for showing the outline of a system of a preferred embodiment of the invention;

FIG. 2 is a schematic drawing for explaining the relation between servers and terminals in the preferred embodiment of the invention;

FIG. 3 is a diagram showing the whole processing flow of the preferred embodiment of the invention;

FIG. 4 is a schematic diagram for explaining a link of a remodeling example included in a remodeling estimate request between a consumer and a contractor;

FIG. 5 is a diagram for explaining screens and a processing flow relating to services for consumers in the preferred embodiment of the invention;

FIG. 6 is a diagram for explaining screens and a processing flow relating to services for contractors in the preferred embodiment of the invention;

FIG. 7 is a diagram showing an example of a remodeling estimate request generation page; and

FIG. 8 is a diagram showing an example of an estimate generation page.

Main reference numerals used in these drawings are explained as follows:

1 system center 2 Internet
3 real estate auctioning server
5 consumer-A terminal 7 consumer-B terminal
9 contractor-A terminal 11 Web server
13 mail server 16 administrator terminal
15, 251 router 17 database server 19 database
23 contractor-B terminal 25 real estate agent shop
253 touch panel terminal 255 shop terminal
257 shop server
191 contractor registration database
193 consumer registration database
195 estimate information database
197 estimate request case database
199 remodeling example database

### DETAIL DESCRIPTION OF THE PREFERRED EMBODIMENTS

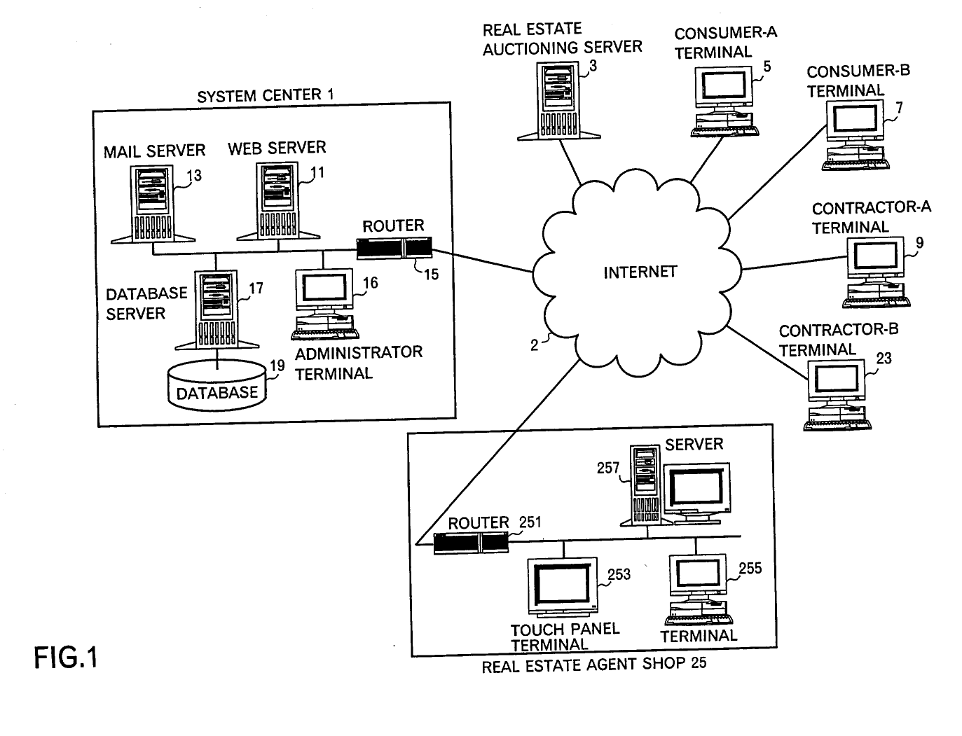

FIG. 1 shows the outline of a system configuration of a preferred embodiment of the invention. In FIG. 1, a system center 1, a real estate auctioning server 3, a consumer-A terminal 5, a consumer-B terminal 7, a contractor-A terminal 9, a contractor-B terminal 23, and a real estate agent shop 25 are connected to the Internet 2. The consumer-A terminal 5, the consumer-B terminal 7, the contractor-A terminal 9, and the contractor-B terminal 23 are normal computers including, for example, Web browsers, and there is also a case where they are connected to the Internet 2 through servers (note shown) The Internet 2 can be replaced by another network.

The system center 1 is connected to the Internet 2 through, for example, a router 15. A mail server 13, a Web server 11, and a database server 17 for managing a database 19 are connected to the router 15. The Web server 11 and the database server 17 constitute the main portion of this remodeling brokerage system. In FIG. 1, although only one server for each kind is shown, same functions can also be achieved by plural servers. Further, the database 19 includes plural kinds of databases. An administrator terminal 16 operated by a system administrator or the like is connected to the router 15.

The real estate agent shop 25 is connected to the Internet 2 through, for example, a router 251. A shop server 257, a touch panel terminal 253 and a shop terminal 255 are connected to the router 251.

The mail server 13, the Web server 11, and the database server 17, which is provided to the system center 1, cooperate with one another to perform a processing for remodeling brokerage. At this time, the system administrator inputs necessary instructions to these servers through the administrator terminal 16.

For example, when a seller desiring to sell a real estate property inputs information of the real estate property in a predetermined form, the real estate auctioning server 3 stores the information of the real estate property, and enables a person who desires to purchase to search such information. The person who desires to purchase searches real estate properties, which meet a desired condition, through the real estate auctioning server 3, and in the case where a real estate property meeting the desired condition is found, the person registers a bid containing a bid price into the real estate auctioning server 3. The seller of the real estate property determines a selling destination for selling from a bid list, and registers him or her as a successful bidder in the real estate auctioning server 3. A mail is sent to the successful bidder from the real estate auctioning server 3. Incidentally, the real estate property auctioning system can provide support services relating to transaction procedures such as investigation of right or contract support after the successful bidder is determined. The seller of the real estate property and the bidder can register requests for receiving various support services into the real estate auctioning server 3, and when the successful bidder is determined, a support service provider for providing the specified support service is selected. This selected support service provider is registered in the real estate auctioning server 3, and a mail notifying the selection is sent from this server 3. Besides, the real estate auctioning server 3 provides various kinds of information, for example, a link to the remodeling brokerage system of this embodiment. The real estate auctioning server 3 is, for example, a combination of a Web server, a database server, and a mail server, and is connected to the Internet 2. Thus, the server is given a URL (Uniform Resource Locator) as information indicating the location on the network.

A consumer A operates the consumer-A terminal 5, or a consumer B operates the consumer-B terminal 7 to input a remodeling estimate request, browses estimates to the estimate request from contractors, and selects a contractor to which an order for the remodeling is to be issued. When inputting the remodeling estimate request, the consumer extracts remodeling execution examples from the remodeling example database included in the database 19, and can use them to generate the estimate request. Although described later in detail, when a remodeling example close to a remodeling imaged by the consumer is included in the remodeling estimate request, the consumer can explain the remodeling relatively easily, and the remodeling contractor can grasp the content of the request of the consumer.

A contractor A operates the contractor-A terminal 9, or a contractor B operates the contractor-B terminal 23 to browse the remodeling estimate request, inputs an estimate containing an estimated sum of money with respect to the remodeling estimate request, and browses an estimate (bid) result. In case the remodeling estimate requester has inputted the information regarding the remodeling example, the remodeling contractor can refer to the remodeling example when browsing the remodeling estimate request, and can use it for creation of the estimate.

This embodiment is designed so that only the ordered remodeling contractor for which ordering has been determined can known who is the remodeling estimate requester. This prevents a remodeling contractor from using this remodeling brokerage system to only grasp latent customers. On the other hand, the consumer may be enabled to grasp the remodeling contractor who inputted the estimate or may not be enabled. In case it is known who is the remodeling contractor having inputted the estimate, a contractor to which an order is to be issued can be determined after consideration to not only the price, but also the reliability of the contractor. However, if the remodeling contractors who can be registered in this system are examined in advance by the organizer of this system, and only the contractors having execution capability and reliability of a certain standard can input the estimates, it is also possible to make the remodeling contractor having inputted the estimate anonymous to the consumer.

The real estate agent shop 25 is such a store that for example, information of rental real estate properties stored in the shop server 257 is searched by a customer through the touch panel terminal 253, and in the case where the customer finds a desired rental real estate property, an intermediary service concerning the property is carried out. A staff member of the real estate agent shop 25 uses, for example, the shop terminal 255 and carries out business such as input of customer information and output of a contract document. In addition, in the real estate agent shop 25, a remodeling wisher not having a personal computer or the like uses the touch panel terminal 253 or the shop terminal 255 to input a remodeling estimate request, or has the staff member of the real estate agent shop 25 use the shop terminal 255 to input. After inputting the remodeling estimate request, the remodeling wisher again visits the shop, uses the touch panel terminal 253 or the shop terminal 255 to browse estimates from remodeling contractors, and can determine a contractor to which an order is to be issued.

Incidentally, a branch store of the organizer of this remodeling brokerage system or a franchise store can become, for example, the real estate agent shop 25.

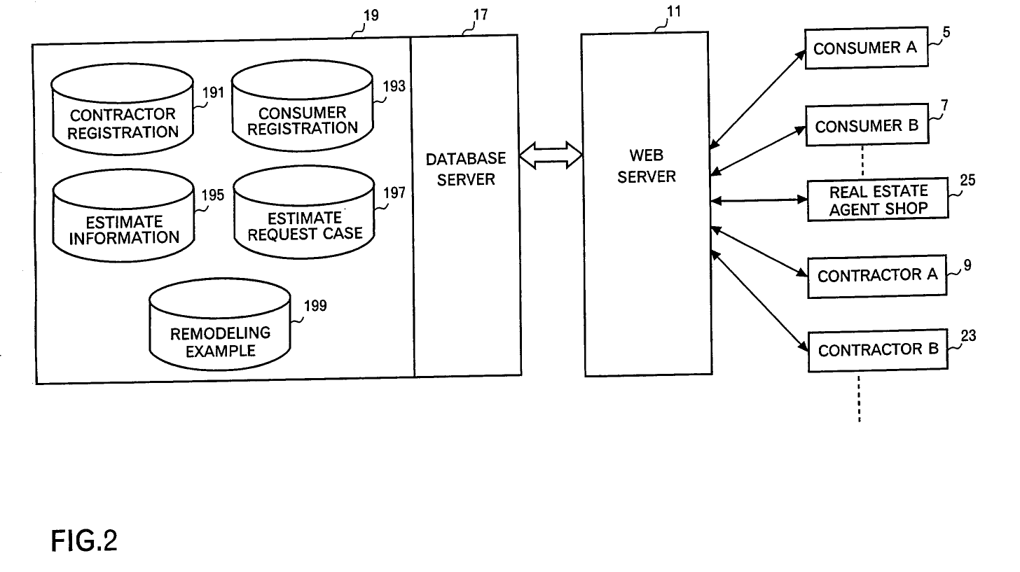

FIG. 2 schematically shows information exchanges between the servers and the terminals included in the system shown in FIG. 1. The database server 17 manages, for example, a remodeling contractor registration database 191, a consumer registration database 193, an estimate request case database 197, an estimate information database 195, and a remodeling example database 199, which are included in the database 19. That is, the database server 17 registers data received from the Web server 11 into the database 19 or outputs data from the database 19 to the Web server 11.

The Web server 11 obtains necessary information from the database server 17, and outputs it to the consumer-A terminal 5, the consumer-B terminal 7, the contractor-A terminal 9, the contractor-B terminal 23, and the terminals of the real estate agent shop 25. On the other hand, information inputted to the browser of each terminal is transferred to the database server 17 through the Web server 11, and is registered by the database server 17 into the database in which it should be registered. In this embodiment, although the information exchange between the Web server 11 and the respective terminals becomes the main processing, the information exchange in relation to the mail server 13 can be included. For example, in the case where a remodeling contractors who can carry out a remodeling in regard to a remodeling estimate request are selected, the mail server 13 can also be configured so as to transmit e-mails to request the selected remodeling contractors to input an estimate since the contractor is selected. At this time, for example, the remodeling estimate request is inputted from the Web server 11 to the database server 17, the database server 17 registers the remodeling estimate request in the estimate request case database 197, the database server 17 selects the remodeling contractors from the information of the contractor registration database 191, and the mail addresses of the remodeling contractors registered in the contractor registration database 191 are outputted to the mail server 13, so that the mail server 13 can transmit the e-mails as mentioned above. It is also possible to notify the consumer by e-mail that the estimate is inputted by the remodeling contractor. At this time, for example, the estimate is inputted to the database server 17 from the Web server 11, the database server 17 registers the estimate in the estimate information database 195, and the database server 17 outputs the mail address of the remodeling estimate requester, who is registered in the consumer registration database 193 and corresponds to the estimate, to the mail server 13, so that the mail server 13 can transmit the e-mail as mentioned above. Incidentally, it is also possible to register a remodeling estimate request or an estimate concerning the remodeling estimate request in an e-mail format.

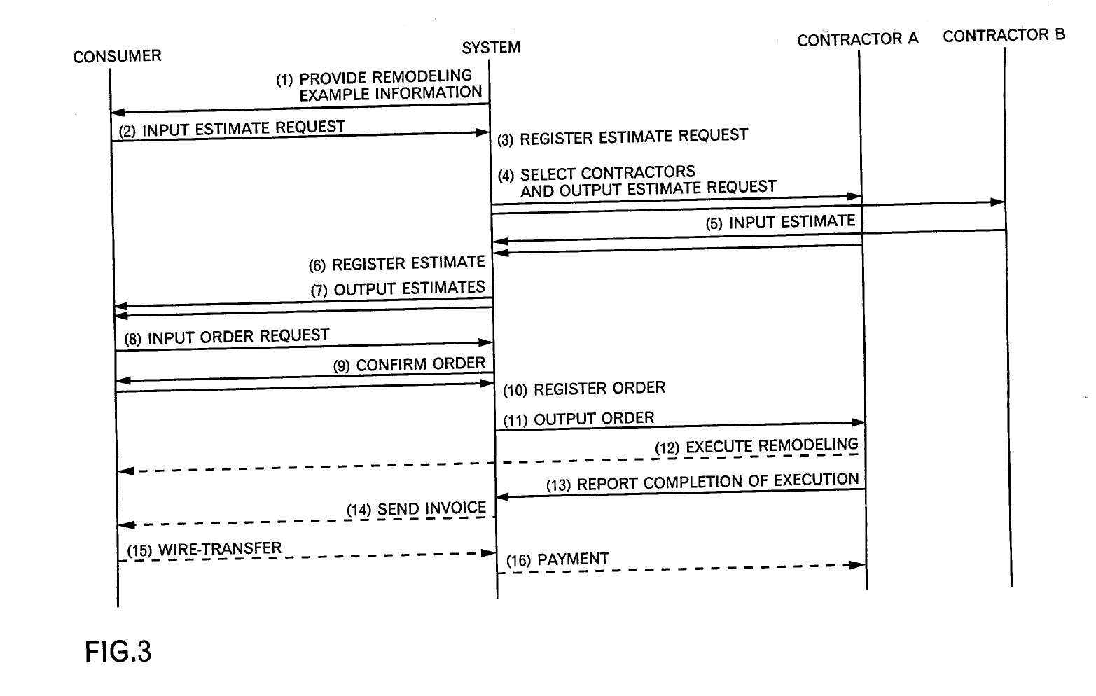

FIG. 3 shows a flow of the whole processing of this remodeling brokerage system. In this remodeling brokerage system, the remodeling example information stored in the remodeling example database 199 included in the database 19 can be searched by the consumer terminal operated by the consumer (FIG. 3, step (1)). The remodeling example information includes, for example, image information before execution and after execution for each menu of a roof, spout, entrance, kitchen, bath, and the like, and information of expenses etc. When a search condition is inputted from the consumer-A terminal 5 or the consumer-B terminal 7, the Web server 11 transfers the search condition to the database server 17, and the database server 17 extracts an example or examples meeting the received search condition from the remodeling example database 199. Then, the Web server 11 outputs the example or examples transferred from the database server 17 and meeting the search condition to the terminal 5 or 7.

The consumer operates the consumer terminal to input the remodeling estimate request to the Web server 11 (step (2)) . The Web server 11 transfers the content of the remodeling estimate request to the database server 17, and the database server 17 registers it in the estimate request case database 197 (step (3)). The content of the remodeling estimate request includes, for example, a consumer ID, a remodeling place, a description of remodeling content, a detailed explanation, information of examples to be referred to, an execution timing, a price range, a settlement method, information concerning the location of a real estate property as an object of the remodeling, the type of a house, room arrangement in the house, date of completion of the real estate property, remodeling history, and the like. Although the example information to be referred to will be described later in detail, for example, remodeling examples to be referred to are made searchable from a Web page for generation of a remodeling estimate request, and a suitable example number or an example symbol is cited from the searched remodeling examples.

After the remodeling estimate request is registered, the database server 17 selects registered remodeling contractors who can carry out the remodeling, from the contractor registration database 191. For example, on the basis of the location of the real estate property as the object of the remodeling included in the remodeling estimate request, the remodeling contractors are selected. Besides, it is also possible to select the contractors in further consideration of the remodeling part etc. included in the remodeling estimate request. In order to use the remodeling brokerage system, the remodeling contractor must be registered in the contractor registration database 191 in advance. At the registration, there is also a case where the organizer of this system examines the execution capability and reliability. The database server 17 enables the selected registered remodeling contractors to browse the remodeling estimate request. When the selected registered remodeling contractor actually requests browsing through the Web server 11, the database server 17 extracts the remodeling estimate request from the estimate request case database 197 to transfer it to the Web server 11, and the Web server 11 outputs it to the terminal of the requesting contractor (step (4)). Here, the executable remodeling contractors are selected in advance, however, it is possible that each time the remodeling contractor instructs search of remodeling estimate requests to which an estimate can be inputted, the database server 17 judges for each remodeling estimate request whether the remodeling contractor can carryout the remodeling, and the content of the estimate request which is judged to be capable of being carried out is presented to the remodeling contractor who instructed the search.

In FIG. 3, the contractor A and the contractor B are the selected registered remodeling contractors. The remodeling estimate request outputted to the contractor A and the contractor B also includes information of remodeling example or examples to be referred to. For example, it is also possible to adopt such a configuration that the Web page including a link to the remodeling example information specified by the remodeling estimate requester is outputted to the terminals of the contractors A and B, and in the case where the contractors A and B make a request, the Web server 11 outputs the remodeling example information of the link destination to the terminals of the contractors A and B.

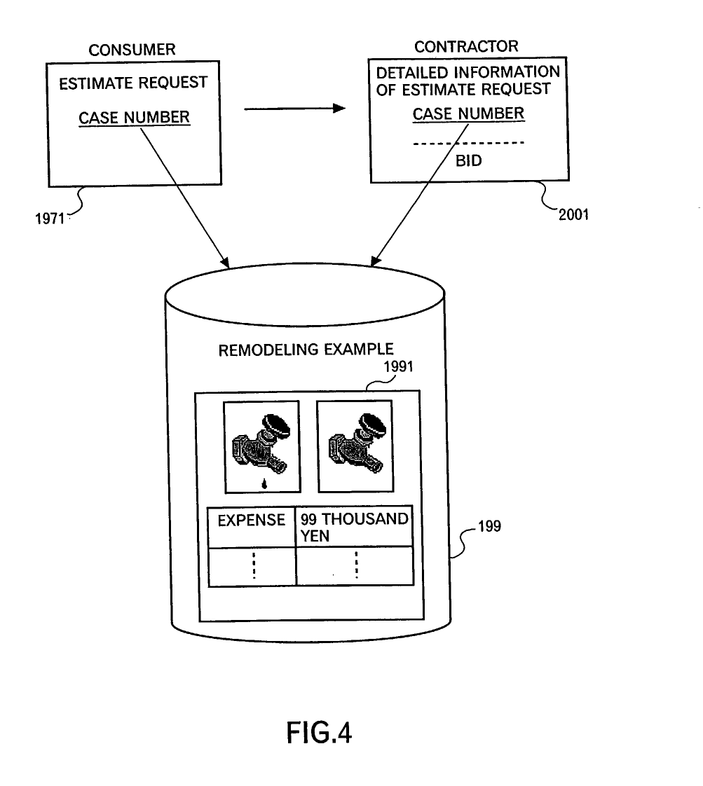

FIG. 4 is a schematic drawing of transmission of the remodeling example information. The consumer operates the terminal to designate a suitable remodeling example number in a Web page 1971 for the remodeling estimate request. This example number is the number of remodeling example information 1991 stored in the remodeling example database 199. This remodeling example information 1991 includes, as shown in FIG. 4, image information before execution at the left side, image information after execution at the right side, and information of expenses at the lower part. On the other hand, a Web page 2001 on which a contractor operates a terminal to get detailed information of the estimate request and to make a bid (estimate) , includes the example number included in the remodeling estimate request and the link to the remodeling example information 1991. When making a bid, the contractor can more clearly grasp the intention of the remodeling estimate requester through the remodeling example, and can more suitably estimate.

In the case where the contractors A and B desire to receive an order with respect to this remodeling estimate request, they operate the terminals to input estimates to the Web server 11 (step (5)). The Web server 11 transfers the contents of the estimates to the database server 17, and the database server 17 registers them into the estimate information database 195 (step (6)) . The estimate includes a desired date of construction start, a period of construction, a comment, an estimate of materials, a total estimated price, and the like.

The database server 17 enables the consumer, who registered the remodeling estimate request as the origin of the estimate, to browse the estimates registered by the contractors A and the contractor B as stated above. In the case where the consumer requests the estimates actually registered through the Web server 11, the database server 17 extracts the estimates from the estimate information database 195 and transfers them to the Web server 11. The Web server 11 outputs the received contents of the estimates to the terminal operated by the consumer (step (7)). The consumer examines the contents of the estimates displayed on the terminal and determines a contractor to which an order is to be issued. In the case where not only the estimate price but also the execution capability and reliability of the remodeling contractor is judged by the consumer, the system side does not determine that the contractor presenting the lowest estimate price is a successful bidder, but presents the estimate results to the consumer who made the remodeling estimate request. The consumer checks, for example, a column of a contractor to be ordered on the Web page, and presses an order request button. Then, the order request of the content specified by the consumer is inputted to the Web server 11 (step (8)).

The Web server 11 outputs an order confirmation Web page including the order content to the terminal operated by the consumer for the confirmation (step (9) ) . The consumer confirms the content of the order and if there is no problem, the consumer returns an order determination response to the Web server 11. In case the order is cancelled, the consumer returns an order canceling response to the Web server 11. Here, on the assumption that the order determination response is returned, a description will be given below.

The Web server 11 receiving the order determination response transfers the order content including the information of the ordered remodeling contractor to the database server 17, and the database server 17 registers it in, for example, the estimate request case database 197 (step (10)) . Incidentally, a link between the remodeling estimate request for which the order is determined and the estimate may be generated and may be registered. Besides, the database server 17 registers the order determination with respect to the estimate in the estimate information database 195, for which the order is determined. In FIG. 3, it is assumed that the contractor A is determined as the ordered remodeling contractor.

In the case where the contractor A operates the terminal to request the Web page of the estimate result, the Web server 11 outputs the Web page indicating that its estimate to the remodeling estimate request is a successful bid (order-determined) (step (11)). At this stage, the contractor A can know who is the customer registering the remodeling estimate request. For example, a customer detail button is provided on the Web page indicating that the estimate is a successful bid, and in the case where this button is pressed, the database server 17 outputs the consumer information from the consumer registration database 193 to the terminal of the contractor A. Then, the contractor gets in touch with the customer, and actually carries out the remodeling (step (12)).

Incidentally, in FIG. 3, arrows indicated by dotted lines denote that the procedure through the system is not supposed in this embodiment.

Next, the contractor A inputs the completion of execution of the remodeling through the Web server 11 (step (13)). At this time, information, as a remodeling example, to be registered in the remodeling example database 199, for example, the image information before execution and the image information after execution, the price and the materials used can be inputted.

In response to the completion of the execution of the remodeling or at any timing after the order, this remodeling brokerage system prints an invoice of the price for the remodeling execution and sends it to the remodeling orderer (step (14)). Incidentally, in addition to a case where the invoice is sent through the post, there exists a case where a bill is sent by e-mail, or a case where an e-mail is used together.

According to this invoice, the remodeling orderer pays the organizer of the remodeling brokerage system for the price for remodeling execution. For example, wire-transfer is used. The remodeling contractor does not receive money directly. The record of the receipt of money is inputted to the remodeling brokerage system by, for example, the administrator terminal 16 (step (15)). The organizer of the remodeling brokerage system subtracts a commission and the remainder is paid to the remodeling contractor (contractor A in FIG. 3) (step (16)). The record of the payment is also recorded in the remodeling brokerage system by, for example, the administrator terminal 16.

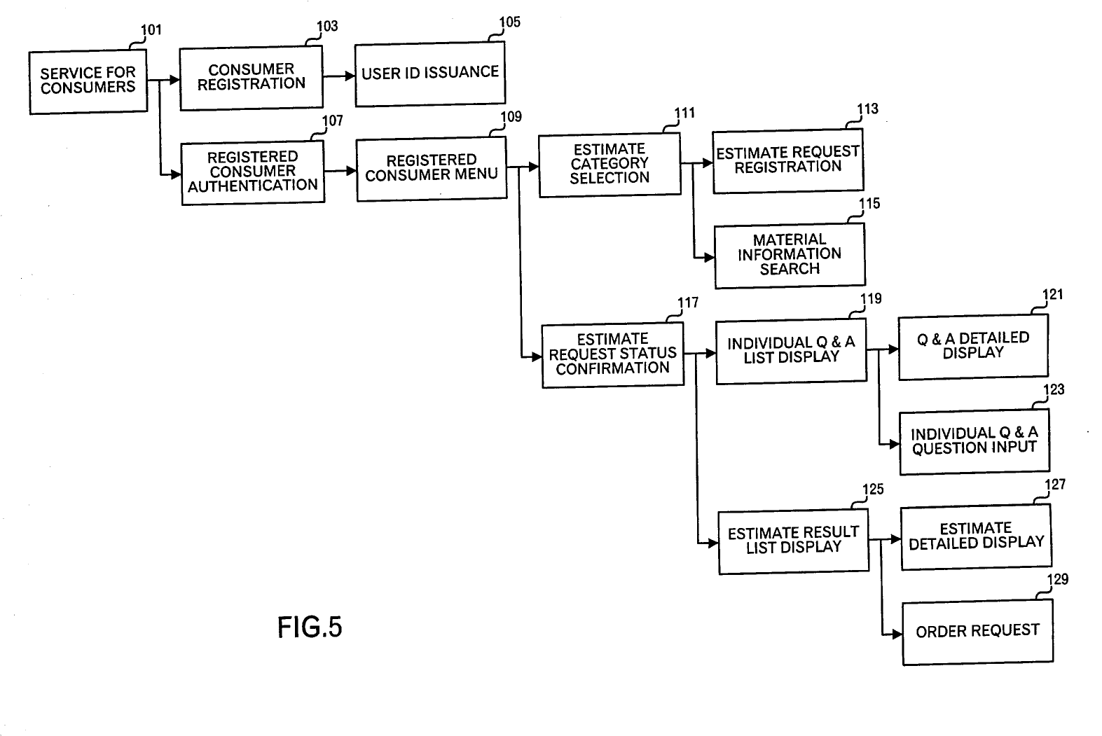

FIG. 5 shows a flow of screens outputted mainly by the Web server 11 to the consumer-A terminal 5 and the consumer-B terminal 7. The Web server 11 acquires necessary data from the database server 17 to output these. Besides, the Web server 11 transfers the information inputted from the consumer-A terminal 5 or the consumer-B terminal 7 to the database server 17, and the database server 17 registers or stores data inputted to a suitable database. FIG. 5 partially includes a processing of the database server 17 as well.

A top page can proceed to a top page 101 of service for consumers, and the top page 101 of service for consumers can proceed to a consumer registration page 103 and a registered consumer authentication page 107.

In order to input a remodeling estimate request, the consumer must first register into this system. Columns for registration of, for example, an address, a name, a telephone number, a FAX number, an e-mail address, and etc. are provided on the consumer registration page 103. The information inputted on this consumer registration page 103 is registered in the consumer registration database 193 by the database server 17. Then, a user ID is issued, and a user ID issuance page 105 including, for example, the user ID and a password is outputted to the consumer by the Web server 11.

On the other hand, in the case where the top page 101 of service for consumers proceeds to the registered consumer authentication page 107, the user ID and the password presented on the user ID issuance page 105 are inputted by the consumer, and the Web server 11 performs an authentication processing using them.

When this authentication processing is completed without any trouble, the page proceeds to a registered consumer menu page 109. This registered consumer menu page 109 can proceed to an estimate category selection page 11 and an estimate request status confirmation page 117. That is, the registered consumer menu page 109 includes links to these pages.

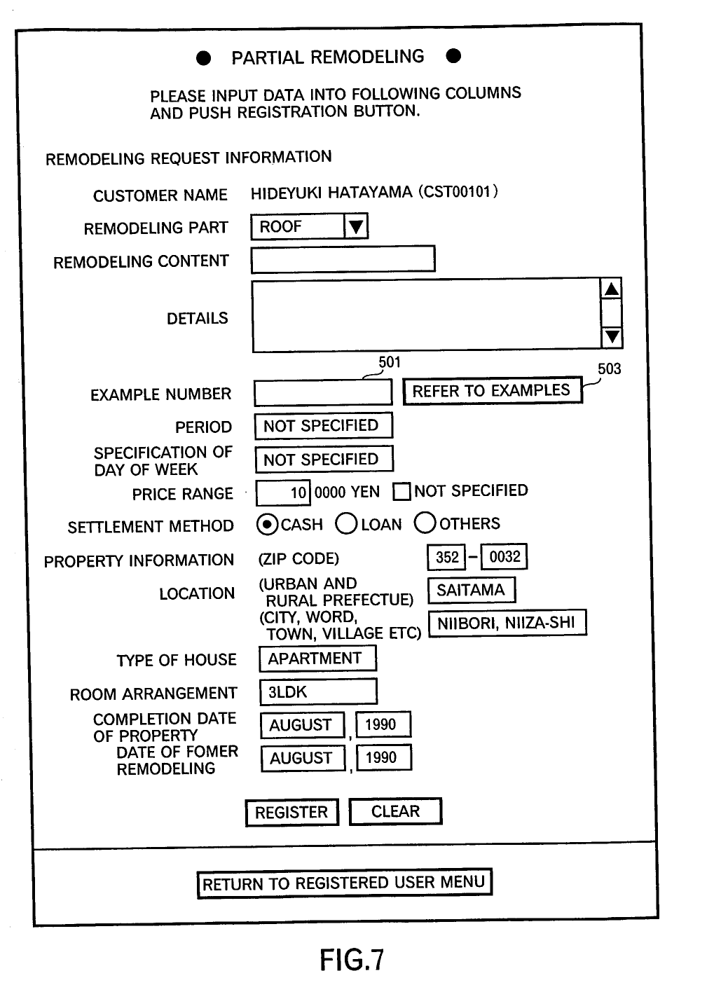

On the estimate category selection page 111, it is possible to select a category such as only attachment of each material, roof, spout, entrance, room furnished in Western style, Japanese-style room, floor, kitchen, toilet, lavatory, bathroom, balcony, sash, furniture, exterior, gardening, or combination of these. Here, for example, in the case where the roof is selected, the page proceeds to an estimate request registration page 113 of the roof. FIG. 7 shows an example of the estimate request registration page 113 of the roof.

In FIG. 7, the roof is regarded as a kind of partial remodeling, and is first indicated that this is the partial remodeling. Then, as remodeling request information, there exist entry or selection columns of a customer name (here, it is automatically entered since authentication has been finished) , a remodeling part (here, a roof, however, the remodeling part can be changed here), remodeling content, the details of the remodeling content, an example number 501, a period, specification of a day of the week, a price range (a sum of money is specified or not specified) , and a settlement method (cash, loan, others) . Besides, a “refer to example” button 503 for obtaining the example number 501 is also provided. When this “refer to example” button 503 is pressed, it is possible to search remodeling examples of the remodeling part specified in the column of the remodeling part. The Web server 11 makes the database server 17 search remodeling examples of the roof here in the remodeling example database 199, outputs the search result including image information, and makes the consumer select a remodeling example close to his or her image. The example number of the selected remodeling example is automatically inputted to the example number column 501.

In FIG. 7, there is also provided a column of property information to specify a real estate property of a remodeling object. There are provided columns of a location (zip code/urban and rural prefectures/city, ward, town, village and street number etc.), the type of a house (here, for example, apartment) , room arrangement (here, for example, 3LDK), completion date of the property (here, August 1990) , and date of former remodeling (here, August 1990). The information relating to the location is used for selecting registered remodeling contractors who can carry out this remodeling. Incidentally, there is also a case where remodeling contractors are selected using the information of the remodeling part. Such information is inputted, and if there is no problem, a registration button is pressed, and in case of clearing input, a clear button is pressed. Further, a button for returning to the registered consumer menu page 109 is also provided here. When the registration button is pressed, the input content is transmitted to the Web server 11, the Web server 11 transfers the input content to the database server 17, and the database server 17 registers it in the estimate request case database 197.

The estimate category selection page 111 can proceed to a material information search page 115. This material information search page 115 is a Web page for searching materials in the case where materials necessary for the remodeling are specified. Here, the prices of the materials are also known, and the sum of the price range can be predicted.

An estimate request status confirmation page 117 belonging to a subordinate position of the registered consumer menu page 109 can proceed to an individual Q & A list display page 119 and an estimate result list display page 125.

The individual Q & A list display page 119 includes a list of questions to estimates from remodeling contractors and answers from the remodeling contractors to the questions. As stated above, since the estimate request and the estimate are performed only on the Web, questions to the estimate and answers are also made on the Web page. This individual Q & A list display page 119 can proceed to a Q & A detailed display page 121 and an individual Q & A question input page 123. In the case where a question is inputted on the individual Q & A question input page 123, the answer is indicated on the Q & A detailed display page 121. After such exchanges, the consumer determines a-contractor to which an order for remodeling is to be issued. The Web server 11 transfers the input of the question to the database server 17, and the database server 17 registers it in, for example, the estimate request case database 197. In the case where the question is registered, the mail server 13 may transmit an e-mail containing the description to that effect to the remodeling contractor registering the estimate. By this, the remodeling contractor registering the estimate can easily answer.

The estimate result list display page 125 includes a list of estimates of the selected registered remodeling contractors. On this estimate result list display page 125, for example, a check column is provided for each estimate, and an ordering request is made with respect to a checked estimate. Incidentally, a link to the details of each estimate may be provided, and in case the link is selected, the page proceeds to an estimate detailed display page 127. Here, the details of the estimate can be checked.

When a check is placed on one of the check columns for respective estimates provided on the estimate result list display page 125, and the order request button provided is pressed, the page proceeds to an order request page 129. Here, the estimate selected on the former page is again displayed to make the consumer confirm the order content. Here, when a confirmation button is pressed, the Web server 11 transfers the information concerning the order to the database server 17, and the database server 17 registers the order content or the link information between the estimate request and the estimate with respect to the remodeling estimate request into the estimate request case database 197. Besides, the database server 17 registers the order to the estimate in the estimate information database 195.

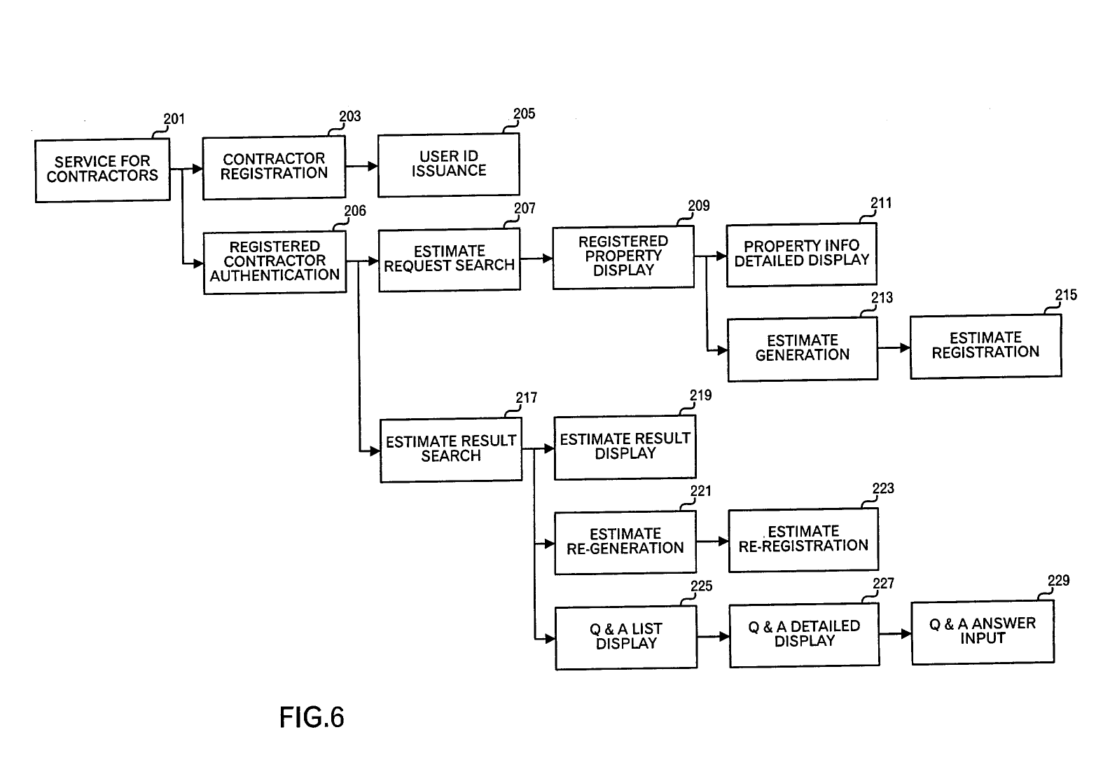

FIG. 6 shows a flow of screens outputted by mainly the Web server 11 to the contractor-A terminal 9 or the contractor-B terminal 23. The Web server 11 acquires necessary data from the database server 17 to output these. Besides, the Web server 11 transfers information inputted from the contractor-A terminal 9 or the contractor-B terminal 23 to the database server 17, and the database server 17 registers or stores data inputted to a suitable database. FIG. 6 partially includes the processing of the database server 17 as well.

A top page can proceed to a top page 201 of service for contractors, and the top page 201 of service for contractors can proceed to a contractor registration page 203 and a registered contractor authentication page 206.

A remodeling contractor must first register in order to input a remodeling estimate. The contractor registration page 203 is provided with columns for registering, for example, an address, a name, a telephone number, a FAX number, an e-mail address, and categories of executable remodeling. The information inputted on the contractor registration page 203 is registered into the contractor registration database 191 by the database server 17. Then, a user ID is issued, and a user ID issuance page 205 including, for example, the user ID and a password are outputted to a remodeling contractor by the Web server 11.

On the other hand, in the case where the top page of service for contractors proceeds to the registered contractor authentication page 206, the remodeling contractor is urged to input the user ID and the password presented on the user ID issuance page 205, and the Web server 11 performs an authentication processing using them.

After this authentication processing, the page proceeds to a registered contractor menu page (not shown) , and this registered contractor menu page can proceed to an estimate request search page 207 and an estimate result search page 217.

On the estimate request search page 207, it is possible to select, for example, one of categories specified in the remodeling estimate request. When the remodeling contractor inputs the category through the Web server 11, the database server 17 extracts remodeling estimate requests which are included in the selected category and in which the remodeling contractor is selected as an executable one, from the estimate request case database 197, and the Web server 11 generates a registered property display page 209 by the extracted remodeling estimate requests, and outputs it to the remodeling contractor.

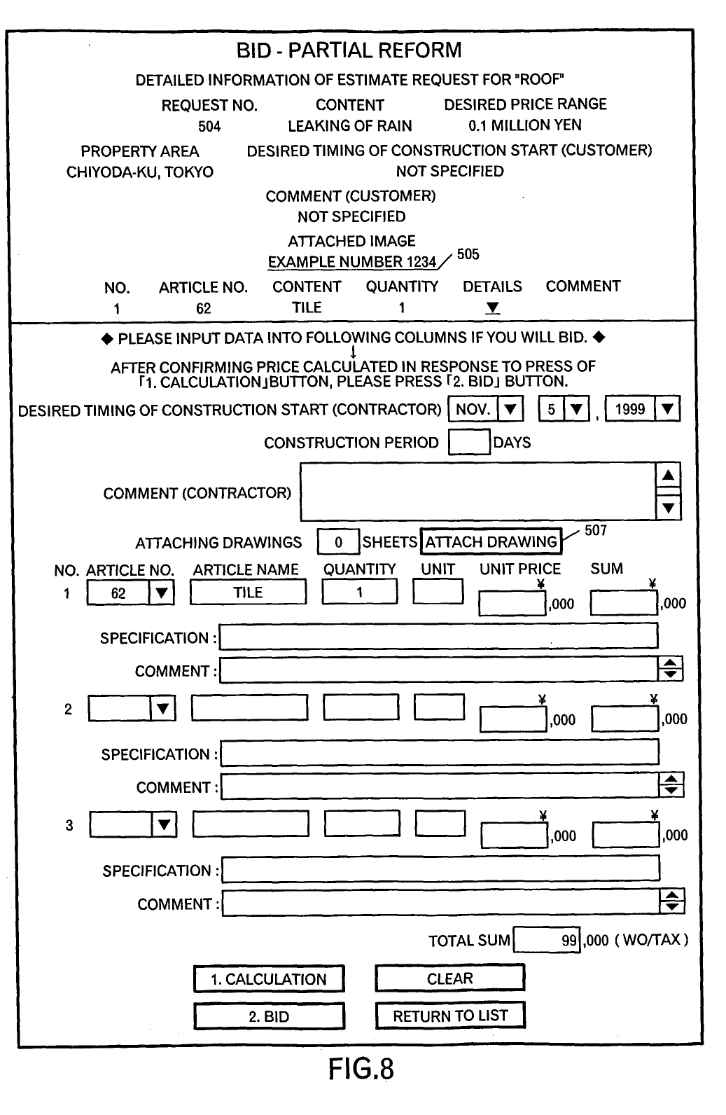

This registered property display page 209 can proceed to a property information detailed display page 211 and an estimate generation page 213 in regard to each estimate request. The property information detailed display page 211 is a page including, for example, all contents of the respective remodeling estimate requests. FIG. 8 shows an example of the estimate generation page 213.

FIG. 8 shows a bid (estimate) to the remodeling estimate request of FIG. 7. The outline of the estimate request is shown at the upper part. FIG. 8 includes a request number (here, 504), the content (here, leaking of rain), a desired price range (here, a hundred thousand yen), a property area (here, Chiyoda-ku, Tokyo), a desired timing of construction start (input by customer, here, it is not specified), a comment (input by customer, here, it is not specified) , attached image (here, the number (for example, 1234) of a remodeling example to be referred to is indicated, and a link to image information is included), and material information (here, tile of article No. 62) .

The content of the bid (estimate) is inputted to the lower part of FIG. 8 in regard to the outline of the estimate request. In FIG. 8, a desired date of construction start (desired date of a contractor), a construction period, comment of a contractor, the number of attaching drawings, material information (for example, article number, article name, quantity, unit, the sum, specification, comment) , and the total sum are inputted. Besides, in FIG. 8, when a “1. calculation” button is pressed, the total sum is automatically calculated, and after the total sum is confirmed, a “2. bid” button is pressed. When a “clear” button is pressed, all the input is reset, and when a “return to list” button is pressed, the page is returned to the former Web page.

Also on the estimate generation page 213 as shown in FIG. 8, an original image can be attached to the estimate so that the remodeling estimate requester can easily grasp the image of the remodeling to be carried out. An “attach drawing” button 507 shown in FIG. 8 is used for this purpose. By pressing the “attach drawing” button 507, a prepared image file can be transmitted to the Web server 11 through, for example, an FTP (File Transfer Protocol) . The Web server 11 transfers the image file and the estimate content inputted in a screen of FIG. 8 to the database server 17, and the database server 17 registers the received estimate content and the image file into the estimate information database 195. By this, the remodeling estimate requester can browse the information.

When the bid (estimate) button is pressed on the estimate generation page 213, the page proceeds to an estimate registration page 215. On this estimate registration page 215, the inputted estimate content is again displayed to urge the remodeling contractor, who made the input, to confirm it. When a confirmation button is pressed on the estimate registration page 215, the estimate content is normally registered into the estimate information database 195.

On the other hand, in the case where the registered contractor menu page proceeds to the estimate result search page 217, the page can proceed to an estimate result display page 219 including an estimate result list concerning the estimate request to which the remodeling contractor registered the estimate, an estimate re-generation page 221 for again estimating as a result of referring to estimates of other contractors concerning the estimate request to which the estimate was registered, and a Q & A list display page 225 on which questions to the estimate from the estimate requester and answers are displayed in a list.

The estimate result display page 219 includes a list of the estimates registered by the remodeling contractor, and also includes information as to whether or not the contractor is selected as one to which an order is to be issued. In the case where a contractor to which an order is to be issued has not been determined, the description to that effect is also included. When one in the list is selected, more detailed estimate information is indicated. That is, the page includes the estimate information registered by the remodeling contractor and the information as to whether the contractor is selected as one to which an order is to be issued. In case a contractor to which an order is to be issued is not determined, the estimate contents of the remodeling contractor and other remodeling contractors are indicated. By this, it is possible to judge whether an estimate is again to be registered.

In the case where the estimate is again to be registered, the page proceeds to the estimate re-generation page 221. The content of this Web page is similar to the estimate generation page 213. When information necessary for the estimate is inputted on the estimate re-generation page 221, the page proceeds to an estimate re-registration page 223. This estimate re-registration page 223 is also similar to the estimate registration page 215. Because an estimate is made again, it is also possible to make the screen different from the estimate generation page 213 and the estimate registration page 215.

Since there is a case where a question to the estimate is registered from the estimate requester, in this case, the page proceeds to the Q & A list display page 225. On the Q & A list display page 225, for example, a mark is put on a question waiting for an answer, so that the remodeling contractor can easily answer. For example, when a question waiting for an answer is selected on the Q & A list display page, the page proceeds to a Q & A detailed display page 227. Here, the details of the question of the estimate requester are indicated. In the case where an answer is inputted, the page proceeds to an answer input page 229, and the answer is inputted. When an answer input button is pressed, a Web page including the content of the answer is displayed, and the answer is registered by pressing a confirmation button. That is, the content of the answer is transferred from the Web server 11 to the database server 17, and the database server 17 registers it into the estimate request case database 197.

Besides, the following configuration can also be adopted. That is, an answer to a question is inputted to an answer column provided under the question of the Q & A detailed display page 227. Then, when the answer button is pressed, the page proceeds to the Q & A answer input page 229, and the inputted answer is confirmed. When a confirmation button provided on the Q & A answer input page 229 is pressed, the Web server 11 transfers the answer content to the database server 17, the database server 17 registers the received content of the answer into the estimate request case database 197. By this, the estimate requester can obtain the answer to the estimate.

The Web server 11, the mail server 13, the database server 17, and the administrator terminal 16 are programmed so as to carry out the processing as described above.

The embodiment described above is one example and various modifications are possible. The screen flow diagrams of FIGS. 5 and 6 are examples, and screens can be added, or screens irrelevant to the gist of the invention can be deleted. Further, the screen configuration examples of FIGS. 7 and 8 are mere examples, and the arrangement of the input columns can be moved, and the display contents can also be changed to link destinations. The Web server 11 provides reference information to the consumer, and it is also possible to add, as link destination, the real estate auctioning server and a server of loan estimate important to real estate property dealings. Besides, since information in which a secret must be kept on the network is inputted to some Web pages, in that case, for example, a SSL (Secure Socket Layer protocol) is used.

As described above, the processing for selecting the remodeling contractors who can register the estimate may be carried out when the remodeling contractor searches the remodeling estimate requests for which the estimate can be given, or can also be carried out in advance at the time of registration of the remodeling estimate request. Further, it is also conceivable not to carry out the selection processing of the remodeling contractors who can register the estimates.

In the remodeling brokerage system, it is also possible to include a remodeling material selling/ordering page for remodeling contractors. By this, the business of the remodeling contractors becomes easier.

As described above, the system and method according to this invention can be provided which intermediates between a remodeling requester who requests a remodeling associated with a real estate property online and a remodeling contractor.

Besides, the online remodeling brokerage system and method can be provided which facilitates the expression and grasp of the remodeling execution content by a remodeling requester and a remodeling contractor online.

What is claimed is:

1. A remodeling brokerage system for brokering a remodeling associated with a real estate property, comprising:
means for registering a remodeling estimate request;
output means for outputting a content of said remodeling estimate request to registered remodeling contractors;
means for registering estimates from said registered remodeling contractors with respect to the registered remodeling estimate request; and
means for registering information concerning an order in response to selection of a remodeling contractor to which an order is to be issued among remodeling contractors who registered said estimates.

2. The remodeling brokerage system as set forth in claim 1, wherein said output means outputs said content of said registered remodeling estimate request to said registered remodeling contractors who can carry out the remodeling specified by said remodeling estimate request.

3. The remodeling brokerage system as set forth in claim 2, further comprising:
means for selecting said registered remodeling contractors who can carry out the remodeling specified by said remodeling estimate request based on a location of a real estate property where an object of said remodeling estimate request exists.

4. The remodeling brokerage system as set forth in claim 1, wherein said remodeling estimate request includes information concerning a remodeling example to be referred to.

5. The remodeling brokerage system as set forth in claim 4, wherein said output means outputs said information concerning the remodeling example included in said remodeling estimate request to said registered remodeling contractors who can carry out the remodeling specified by said remodeling estimate request.

6. The remodeling brokerage system as set forth in claim 1, further comprising:
means for enabling to search information concerning a remodeling example to be referred to if a remodeling estimate request is registered.

7. The remodeling brokerage system as set forth in claim 1, further comprising:
means for presenting said estimate registered for said remodeling estimate request to a person who registered said remodeling estimate request.

8. The remodeling brokerage system as set, forth in claim 1, wherein said estimate includes image information representing a content of the remodeling.

9. Are modeling brokerage method for brokering a remodeling associated with a real estate property, said remodeling brokerage method comprising the steps of:
registering a remodeling estimate request;
outputting a content of said remodeling estimate request to registered remodeling contractors;
registering estimates from said registered remodeling contractors with respect to said registered remodeling estimate request; and
registering information concerning an order in response to selection of a remodeling contractor to which an order is to be issued among remodeling contractors who registered said estimates.

10. The remodeling brokerage method as set forth in claim 9, wherein said remodeling estimate request includes information concerning a remodeling example to be referred to.

11. A program embodied on a medium for causing a computer to broker a remodeling associated with a real estate property, said program comprising the steps of:
registering a remodeling estimate request;
outputting a content of said remodeling estimate request to registered remodeling contractors;
registering estimates from said registered remodeling contractors with respect to said registered remodeling estimate request; and
registering information concerning an order in response to selection of a remodeling contractor to which an order is to be issued among remodeling contractors who registered said estimates.

12. A remodeling estimate request method comprising the steps of:
sending a search condition of a remodeling example to a server; and
sending a remodeling estimate request including information concerning a remodeling example to be referred to among received remodeling examples.

13. A remodeling estimate registration method comprising the steps of:
receiving a remodeling estimate request from a server;
sending a request for acquiring information concerning a remodeling example indicated in said remodeling estimate request to said server;
receiving said information concerning a remodeling example for said request from said server; and
sending information concerning an estimate for said remodeling estimate request to said server to register said estimate.
